(19) United States
(12) Patent Application Publication
(10) Pub. No.: US 2011/0066323 A1
(43) Pub. Date: Mar. 17, 2011

(54) FAILURE DETERMINATION DEVICE FOR SHIFT SWITCHING MECHANISM AND FAILURE DETERMINATION METHOD

(75) Inventor: Naoki Nishimura, Nagoya-shi (JP)

(73) Assignee: TOYOTA JIDOSHA KABUSHIKI KAISHA, Toyota-shi, Aichi-ken (JP)

(21) Appl. No.: 12/991,773

(22) PCT Filed: Apr. 13, 2009
(86) PCT No.: PCT/JP2009/057437

§ 371 Date: Nov. 9, 2010

(30) Foreign Application Priority Data
May 13, 2008 (JP) 2008-126252

(51) Int. Cl. F16H 59/68

(52) U.S. Cl. 701/35; 701/29

(57) ABSTRACT

An SBW-ECU executes a program including the steps of: if there is a request to switch a shift position to another for the first time after the engine is started and the target position is not the D position, setting the D position as the current target position; controlling an actuator to attain the target position; if the actual shift position does not correspond to the target shift position, notifying that some failure has arisen; otherwise, resetting a target shift position based on a shift signal; and controlling the actuator to attain the reset target shift position.

### TECHNICAL FIELD

The present invention relates generally to determining whether a shift switching mechanism switching a shift position by an actuator has failed, and particularly to technology used to detect at an early stage whether the shift switching mechanism has failed.

### BACKGROUND ART

A shift switching mechanism switching a shift position by an actuator in response to an operation of a shift lever by a driver has conventionally been known.

For the shift switching mechanism, a shift position switching power source, or the actuator, is implemented as an electric motor, e.g., a direct current motor. This eliminates the necessity of mechanically connecting the shift lever to the shift switching mechanism, as required for a typical switching mechanism switching a shift position of an automatic transmission directly by the driver's force exerted to operate the shift lever. As a result, there is no limitation in layout in mounting these components on a vehicle, and an increased degree of freedom in design can thus be achieved. Furthermore, the shift switching mechanism can be easily assembled to the vehicle.

When the shift switching mechanism has some failure, it is necessary to determine the failure with precision and rapidly perform a fail safe process.

For example, Japanese Patent Laying-open No. 2004-125061 (Patent Document 1) discloses a control device for an automatic transmission, that can effectively prevent a vehicle from behaving against the driver's intention. The control device includes: a target range position command means having a plurality of shift range positions corresponding to a plurality of shift ranges of an automatic transmission and operative in response to the driver's switching operation for selecting one of the shift range positions as a target range position, converting the target range position to an electrical signal, and outputting the electrical signal as a target range position signal; an actual range switching means responsive to the target range position signal for actually switching the automatic transmission's shift range; an actual range position detection means for converting the automatic transmission's actual range position to an electrical signal and outputting the electrical signal as an actual range position signal; a shift failure determination means for determining a failure when the target range position signal and the actual range position signal are different; and a power transmission path disconnection means for disconnecting a power transmission path extending from the engine's output shaft via the automatic transmission to a driving wheel when the shift failure determination means determines the failure.

The control device for an automatic transmission as disclosed in the above publication can prevent the vehicle from suddenly starting moving forward/rearward against the driver's intention when the target range position and the actual range position do not match. Furthermore, when the driver operates a shift selecting switch or the like to resolve the mismatch, the power transmission path can again be connected so that a shift range allowing the driver's intended shift range and the transmission's shift range to match can be used to move the vehicle.

### Prior Art Document

### Patent Document

Patent Document 1: Japanese Patent Laying-open No. 2004-125061

### SUMMARY OF THE INVENTION

### Problems to be Solved by the Invention

When the automatic transmission's failure is first detected and the power transmission path is then disconnected, in cold state in particular, the hydraulic pressure's response delays to an increased extent, and a period of time is required after the automatic transmission's failure is detected before the power transmission path is disconnected. As such, there is a possibility that before the power transmission path is completely disconnected, the automatic transmission's failure may cause a shift position to be switched to a shift position that the driver does not intend, and a driving force may be generated. As a result, the driver may recognize that the vehicle does not behave normally.

The control device for an automatic transmission as disclosed in the above publication does not provide any consideration for such a disadvantage, and thus cannot resolve the disadvantage.

The present invention contemplates a failure determination device for a shift switching mechanism, that can detect at an earlier stage that the shift switching mechanism has failed, and a method for determining such failure.

### Means for Solving the Problems

The present invention in one aspect provides a failure determination device for a shift switching mechanism mounted in a vehicle. The shift switching mechanism is operative in response to a switching signal to switch a shift position corresponding to a state of the vehicle to any one of a plurality of shift positions as an actuator is driven. The failure determination device includes: a determination unit for determining whether the actuator is driven, in disengaging a first shift position of the plurality of shift positions in response to the switching signal, for a first time at earliest after the actuator becomes drivable; and a fail determination unit for determining whether the shift switching mechanism has failed from whether a shift position attained after the actuator is driven is different from another shift position of the plurality of shift positions other than the first shift position, as the actuator is driven to switch the first shift position via the other shift position before switching the first shift position to a destined, second shift position in response to the switching signal if the determination unit determines that the actuator is driven for the first time.

In accordance with the present invention the actuator becomes drivable by an operation performed by the driver to start the vehicle when the driver starts driving the vehicle. In other words, when the actuator is driven for the first time at earliest after the actuator becomes drivable can be said to be when the vehicle is stopped and the driver is performing an operation to start driving the vehicle. In that condition, before a first shift position (e.g., the parking position) is switched to a destined shift position, the actuator is driven to switch the first shift position via another shift position to determine whether a shift position attained after the actuator is driven is different from the other shift position and hence whether the shift switching mechanism has failed. Whether the shift switching mechanism has failed can thus be detected at an early stage before the vehicle starts traveling. Furthermore, with the vehicle stopped, detecting that the shift switching mechanism has failed for example when power transmitted to a driving wheel is interrupted or the like to restrict the vehicle's movement, can prevent the vehicle from behaving against the driver's intention. A failure determination device for a shift switching mechanism and a failure determination method that can detect at an early stage that the shift switching mechanism has some defect, can thus be provided.

Preferably, if the determination unit determines that the actuator is driven for the first time, then, the plurality of shift positions are switched in a predetermined sequence with the first shift position serving as a starting point. If the determination unit determines that actuator is driven for the first time then, the fail determination unit determines whether the shift switching mechanism has failed between the first shift position and a sequentially last shift position.

In accordance with the present invention, whether the shift switching mechanism has failed between the first shift position and the sequentially last shift position can be determined to detect whether the shift switching mechanism has some defect for any shift position.

Still preferably, if the second shift position is not the sequentially last shift position, the fail determination unit determines whether the shift switching mechanism has failed as the actuator is driven to switch the current shift position to the sequentially last shift position.

In accordance with the present invention, if the second shift position is not the sequentially last shift position, the actuator can be driven to switch the current shift position to the sequentially last shift position to determine whether the shift switching mechanism has failed to detect whether the shift switching mechanism has some defect for any shift position.

Still preferably, the vehicle has an engine. The fail determination unit determines whether the shift switching mechanism has failed when it is determined that the actuator is driven for a first time after the engine is started.

In accordance with the present invention, a vehicle having an engine mounted therein has the engine started after an actuator becomes drivable (e.g., after ignition is turned on) after the vehicle is stopped, and after the engine is thus started a shift position is switched by the driver's operation or automatically. At the time, the actuator can be driven to switch the shift position to a shift position other than a destined shift position to determine whether the shift switching mechanism has failed to detect whether the shift switching mechanism has failed at an early stage before the vehicle starts to travel.

Still preferably, the other shift position includes a forward driving position. The first shift position is switched to the forward driving position via a shift position other than the first shift position and the forward driving position. If the determination unit determines that the actuator is driven for the first time then, the fail determination unit determines whether the shift switching mechanism has failed as the actuator is driven to switch the first shift position to the forward driving position before switching the first shift position to the second shift position.

In accordance with the present invention, the actuator can be driven to switch the first shift position to the forward driving position to detect whether the shift switching mechanism has failed for any shift position.

Still preferably, the first shift position is a parking position.

In accordance with the present invention, before the parking position is disengaged and the shift position is switched to a destined shift position, the actuator can be driven to switch the shift position to another shift position to determine whether the shift switching mechanism has failed to detect whether the shift switching mechanism has failed at an early stage before the vehicle starts to travel.

Still preferably, the failure determination device further includes: a storage unit for storing the second shift position; and an actuator control unit for controlling the actuator to switch the first shift position to the stored second shift position if it is determined that the shift switching mechanism has not failed in switching to the other shift position.

In accordance with the present invention, when that the shift switching mechanism has failed is not detected, the shift position can be switched to the stored shift position and thus switched in accordance with the switching signal.

Still preferably, the vehicle is provided with a restriction device for restricting the vehicle's movement. The fail determination unit determines whether the shift switching mechanism has failed when the restriction device operates to restrict the vehicle's movement.

In accordance with the present invention, for example when a vehicle has power that is transmitted to a driving wheel interrupted or the like to previously restrict the vehicle's movement, whether the vehicle has the shift switching mechanism failed can be determined, so that if that the shift switching mechanism has failed is detected, the vehicle can be prevented from behaving against the driver's intention.

### BRIEF DESCRIPTION OF THE DRAWINGS

FIG. 1 illustrates a configuration of a vehicle having a failure determination device mounted therein for a shift switching mechanism according to an embodiment.

FIG. 2 illustrates a configuration of the shift switching mechanism.

FIG. 3 is a functional block diagram of an SBW-ECU serving as the failure determination device for the shift switching mechanism according to the present embodiment.

FIG. 4 is a flowchart for illustrating a control structure for a program executed by the SBW-ECU serving as the failure determination device for the shift switching mechanism according to the present embodiment.

FIG. 5 is a timing plot representing an operation of the SBW-ECU serving as the failure determination device for the shift switching mechanism according to the present embodiment.

### MODES FOR CARRYING OUT THE INVENTION

An Embodiment of the present invention will now be described hereinafter with reference to the drawings. In the following description, identical components are identically denoted. Their names and functions are also identical. Accordingly, they will not be described repeatedly in detail.

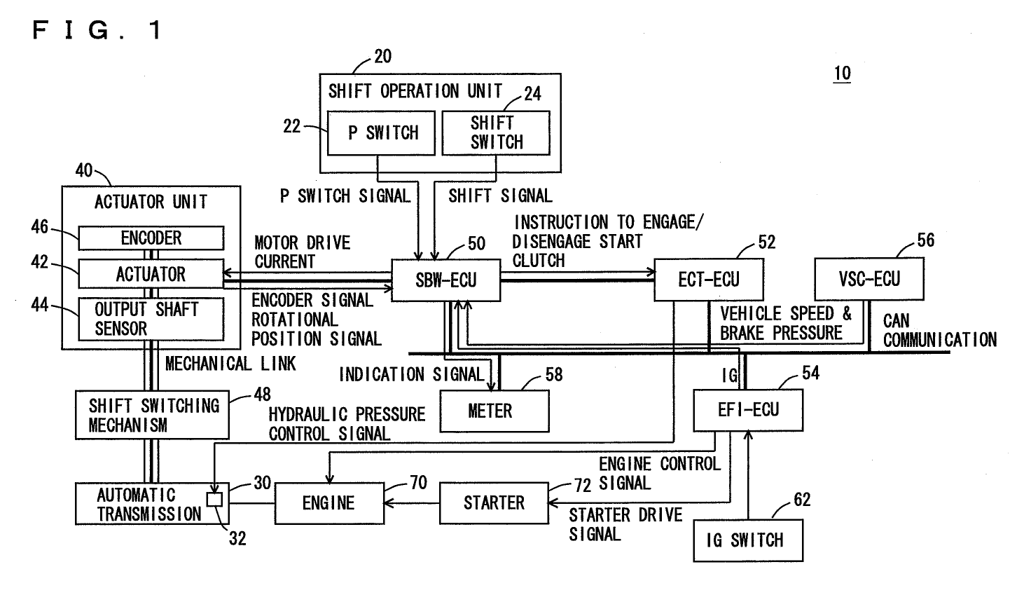

FIG. 1 illustrates a configuration of a shift control system 10 including a failure determination device for a shift switching mechanism according to the present embodiment. Shift control system 10 according to the present embodiment is used to switch the shift position of a vehicle. Shift control system 10 includes a shift operation unit 20, an actuator unit 40, a shift switching mechanism 48, an automatic transmission 30, a shift by wire (SBW)-electronic control unit (ECU) 50, an electronic controlled automatic transmission (ECT)-ECU 52, an electronic fuel injection (EFI)-ECU 54, a vehicle stability control (VSC)-ECU 56, a meter 58, an IG switch 62, an engine 70 and a starter 72.

Shift operation unit 20 includes a P switch 22 and a shift switch 24. Actuator unit 40 includes an actuator 42, an output shaft sensor 44 and an encoder 46.

In the configuration as described above, shift control system 10 functions as a shift by wire system that switches the shift position by electric control for the actuator. Specifically, shift switching mechanism 48 is driven by actuator 42 to switch the shift position. In the present embodiment the failure determination device for the shift switching mechanism is implemented by SBW-ECU 50.

P switch 22 is for switching the shift position between the parking position (hereinafter referred to as “the P position”) and a position other than the parking position (hereinafter referred to as “the non P position”), and includes an indicator (not shown) for indicating the state of the switch to the driver and an input unit (not shown) for receiving an instruction from the driver. The driver inputs an instruction through the input unit to place the shift position in the P position. The input unit may be a momentary switch. A P command signal indicating the instruction from the driver that is received by the input unit is transmitted to SBW-ECU 50. Furthermore, the non P position may be switched to the P position by other than P switch 22. Furthermore, the P position and the non P position may automatically be switched back and forth for example by the accelerator pedal, the brake pedal or the like being operated.

In order to switch the shift position between the P position and the non P position, SBW-ECU 50 controls the operation of actuator 42 that drives shift switching mechanism 48, and presents the state of the current shift position to an indicator (not shown) of meter 58. When the driver presses the input unit of P switch 22, with the shift position in the non P position, SBW-ECU 50 switches the shift position to the P position and presents to the indicator that the current shift position is in the P position.

Actuator 42 is configured of a switched reluctance motor (hereinafter referred to as an “SR motor”), and receives an actuator control signal from SBW-ECU 50 and drives shift switching mechanism 48. Encoder 46 rotates integrally with actuator 42 and detects how the SR motor rotates. Encoder 46 in the present embodiment is a rotary encoder that outputs signals of an A phase, a B phase and a Z phase. SBW-ECU 50 obtains the signals output from encoder 46 and therefrom grasps how the SR motor rotates, and SBW-ECU 50 controls electric conduction for driving the SR motor.

Shift switch 24 is for switching the shift position to a position such as a forward driving position (hereinafter referred to as “the D position”), a rearward driving position (hereinafter referred to as “the R position”) and a neutral position (hereinafter referred to as “the N position”), or for clearing the selection of the P position when the shift position is in the P position. Shift switch 24 receives a switching signal indicating an instruction of the driver (hereinafter referred to as a shift signal), which is in turn transmitted to SBW-ECU 50. In other words, shift switch 24 transmits to SBW-ECU 50 the shift signal indicating the shift position corresponding to the position of an operation member (e.g., a shift lever) operated by the driver. SBW-ECU 50 exercises control for switching the shift position in automatic transmission 30 by actuator 42 based on the shift signal indicating the instruction from the driver, and in addition, presents the state of the current shift position to meter 58.

More specifically, when the shift position corresponding to the position of the shift lever based on the shift signal received from shift switch 24 is different from the shift position based on the amount of rotation of actuator 42 detected by encoder 46 and the like, SBW-ECU 50 drives actuator 42 to switch to the shift position corresponding to the position of the shift lever.

Although automatic transmission 30 is described as a gear type automatic transmission in the present embodiment, automatic transmission 30 is not particularly limited thereto, but may be, for example, a continuously variable automatic transmission.

Automatic transmission 30 is provided with a hydraulic circuit including various valves such as a manual valve, for example, and as the hydraulic circuit varies in hydraulic pressure, the shift position and how power is transmitted vary. More specifically, automatic transmission 30 is provided with a planetary gear mechanism as well as a frictional engagement element such as a brake element and a clutch element that changes the manner of rotation of each rotation element (i.e., a sun gear, a carrier, a ring gear and the like) of the planetary gear mechanism.

The manual valve is provided with a spool valve sliding therein. When the spool valve is moved to the position corresponding to each shift position, the hydraulic circuit varies in hydraulic pressure in accordance with the position to which the spool valve is moved.

At the time, as the hydraulic circuit varies in hydraulic pressure, the frictional engagement element's engagement force varies, and automatic transmission 30 transitions to the state corresponding to each shift position. In other words, the state of power transmission from the engine to a driving wheel in automatic transmission 30 (e.g., any state of forward movement, rearward movement and power interruption, or a gear ratio) varies. These frictional engagement elements have engagement force controlled by ECT-ECU 52 using various solenoid valves provided at the hydraulic circuit.

Automatic transmission 30 has a start clutch 32. Start clutch 32 is a frictional engagement element engaging whenever the vehicle starts moving. Start clutch 32 engages and disengages in response to a hydraulic pressure control signal output from ECT-ECU 52. When start clutch 32 engages, the power transmitted from engine 70 to the driving wheel is interrupted. Note that a frictional engagement element that engages whenever the vehicle starts moving forward and a frictional engagement element that engages whenever the vehicle starts moving rearward may be different.

Shift switching mechanism 48 includes a shaft coupled with actuator 42. The shaft is provided with a detent plate, which will be described later. The detent plate is coupled with the spool valve of the manual valve of automatic transmission 30 with a rod or the like posed therebetween. Note that the manual valve's spool valve may be coupled with the shaft directly.

The shaft is rotated by actuator 42. Furthermore, as the shaft rotates, the spool valve can be moved to a position corresponding to each shift position (i.e., the D, R and N positions).

More specifically, when actuator 42 attains a rotational position corresponding to the D position, the spool valve moves to a position corresponding to the D position. When actuator 42 attains a rotational position corresponding to the R position, the spool valve moves to a position corresponding to the R position. When actuator 42 attains a rotational position corresponding to the N position, the spool valve moves to a position corresponding to the N position.

Although actuator 42 is described as a rotationally driven motor in the present embodiment, actuator 42 is not particularly limited thereto, but may be, for example, a linearly driven motor. In addition, actuator 42 may be operated hydraulically and is not particularly limited to that operated by a motor.

Output shaft sensor 44 senses the rotational position of a shaft 102. Specifically, output shaft sensor 44 is connected to SBW-ECU 50 and transmits to SBW-ECU 50 a signal (a rotational position signal) indicating the rotation angle of shaft 102. SBW-ECU 50 detects the shift position based on the received signal indicating the rotational position. A predetermined range of an output value corresponding to each shift position is stored in a memory of SBW-ECU 50. SBW-ECU 50 determines the currently selected shift position by determining which range corresponding to each shift position the received signal indicating the rotation angle of shaft 102 corresponds to. In addition, in the present embodiment, it is assumed that a change in the output value of output shaft sensor 44 has a linear relationship with respect to a change in the rotational position (angle) of shaft 102. Output shaft sensor 44 is for sensing the rotation angle of shaft 102 that is a physical quantity corresponding to the amount of actuation of actuator 42.

In addition to the oil temperature sensed by an oil temperature sensor (not shown), ECT-ECU 60 controls the shift state of automatic transmission 30 based on the physical quantity related to the state of automatic transmission 30 (e.g., the rotation speed of a turbine, the rotation speed of the output shaft and the rotation speed of the engine).

In addition to an accelerator pedal position sensed by an accelerator pedal position sensor (not shown), EFI-ECU 54 controls the output of the internal combustion engine (or the engine) based on the physical quantity related to the state of the engine (e.g., the water temperature, the amount of intake air and the like).

In addition to the brake hydraulic pressure sensed by a brake pressure sensor (not shown), VSC-ECU 56 controls the brake hydraulic pressure based on the physical quantity related to the behavior of the vehicle (e.g., wheel speed).

Meter 58 presents the state of the vehicle equipment, the state of the shift position and the like. Meter 58 is provided with a display unit (not shown) that displays an instruction, a warning and the like issued by SBW-ECU 50 to the driver.

Engine 70 is coupled with an input shaft of automatic transmission 30. Engine 70 is provided with a starter 72 driven before starting engine 70.

When starter 72 receives a starter driving signal from EFI-ECU 54, it starts driving and cranks engine 70 (i.e., rotates the output shaft of engine 70). As starter 72 is driven, EFI-ECU 54 transmits an engine control signal to engine 70 so as to supply engine 70 with fuel and ignite the fuel. While engine 70 is cranked, it is supplied with fuel, and a mixture of the supplied fuel and air is ignited to start starting the engine.

When IG switch 62 is turned on by the driver, a power supply relay (not shown) is turned on. When the power supply relay is turned on, the electronics mounted on the vehicle are supplied with electric power and each electronics is started. In the present embodiment, when IG switch 62 is turned on, actuator 42 can be supplied with electric power and actuator 42 is drivable.

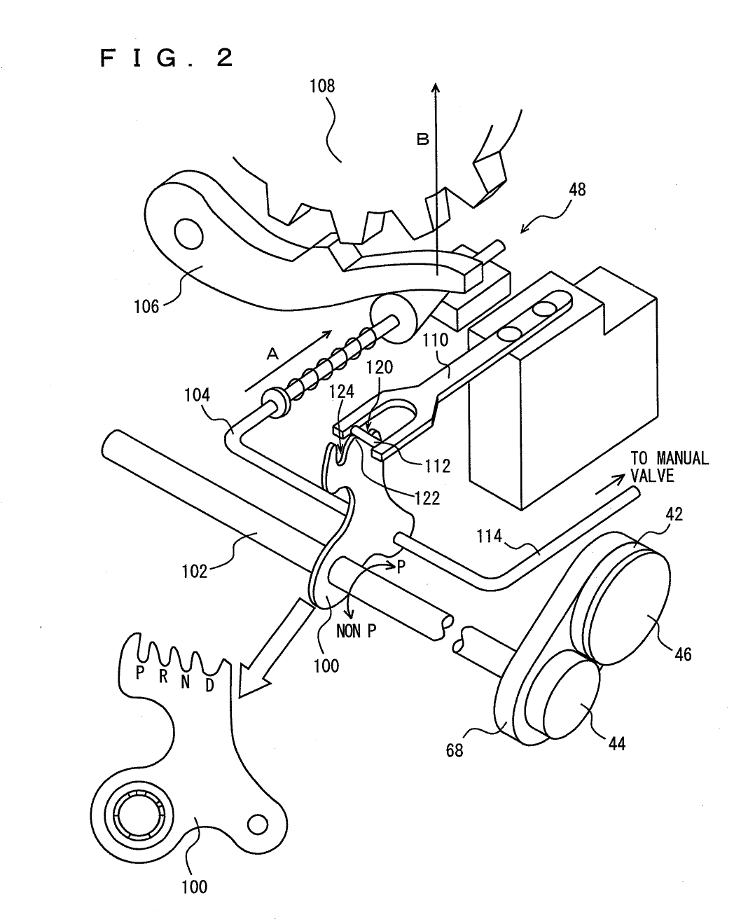

FIG. 2 illustrates a configuration of shift switching mechanism 48. Hereinafter, shift positions include the P position and the non P position, which may include each of the R, N and D positions, and in addition to the D position, may include a D1 position for fixing at a first gear and a D2 position for fixing at a second gear.

Actuator 42 is connected to a shaft 102 with a speed reduction mechanism 68 posed therebetween. More specifically, the rotation speed of actuator 42 is reduced by speed reduction mechanism 68 and thus transmitted to shaft 102. Speed reduction mechanism 68 is configured for example of a plurality of gears combined together.

Shift switching mechanism 48 includes shaft 102 rotated by actuator 42, a detent plate 100 rotated as shaft 102 rotates, a rod 104 operated as detent plate 100 rotates, a parking lock gear 108 fixed to the output shaft of automatic transmission 30, a parking lock pole 106 for locking parking lock gear 108, a detent spring 110 for limiting the rotation of detent plate 100 and fixing the shift position, and a roller 112. Detent plate 100 is driven by actuator 42 and switches the shift position. Actuator 42 is provided with encoder 46. Encoder 46 functions as a counting means for obtaining a counted value corresponding to the amount of rotation of actuator 42.

Encoder 46 is a sensor which generates a pulse signal in a rotational operation by magnets disposed on a rotor of a motor equidistantly and a Hall IC and thus senses the rotor's angle of rotation. Encoder 46 increases a counter value as the amount of rotation of actuator 42 increases (or encoder 46 decreases a counter value for rotation provided in a negative direction). The counter value of encoder 46 is indicated by a signal (hereinafter also referred to as a “count signal”), which is in turn transmitted to SBW-ECU 50. Based on how the counter value increments/decrements, SBW-ECU 50 detects the amount of rotation of actuator 42. Alternatively, SBW-ECU 50 may detect an amount of rotation of shaft 102 from the counter value's increment or decrement and a speed reduction ratio in speed reduction mechanism 68.

Note that while the FIG. 2 perspective view only shows a trough of detent plate 100 (i.e., the P position), in reality, as shown in an enlarged plan view also shown in FIG. 2, detent plate 100 has four troughs corresponding to the four, D, N, R, P positions. In the following description, the D, N, R positions will (collectively) be referred to as the non P position, and how the P position and the non P position are switched back and forth will be described.

FIG. 2 illustrates the state in which the shift position is in the non P position. In this state, parking lock pole 106 does not lock parking lock gear 108, and thus, the rotation of the drive shaft of the vehicle is not prevented. If shaft 102 is turned clockwise from this state by actuator 42, rod 104 is pushed by detent plate 100 in the direction of an arrow A shown in FIG. 2, and parking lock pole 106 is pushed up by a tapered portion provided at the tip of rod 104, in the direction of an arrow B shown in FIG. 2. As detent plate 100 rotates, roller 112 of detent spring 110 situated in one of the two troughs provided at the top of detent plate 100, that is, in a location 120 of the non P position, climbs over a crest 122 and moves to the other trough, that is, to a location 124 of the P position. Roller 112 is provided at detent spring 110 to be capable of rotating in the axial direction of roller 112. When detent plate 100 rotates until roller 112 reaches location 124 of the P position, parking lock pole 106 is pushed up to the location where a protrusion of parking lock pole 106 meshes with a region between the gear teeth of parking lock gear 108. As a result, the drive shaft of the vehicle is mechanically fixed and the shift position is switched to the P position.

In shift control system 10 according to the present embodiment, in order to reduce the load applied to the components of shift switching mechanism 48 such as detent plate 100, detent spring 110 and shaft 102 at the time of switching the shift position, SBW-ECU 50 controls the amount of rotation of actuator 42 to lessen the impact when roller 112 of detent spring 110 climbs over crest 122 and falls.

When actuator 42 has a rotational position, based on an amount of rotation as detected by encoder 46, (or roller 112 has a position relative to detent plate 100), that falls within a predetermined range corresponding to the P position, SBW-ECU 50 determines that the current shift position is the P position.

When actuator 42 has a rotational position, based on an amount of rotation as detected by encoder 46, that falls within a predetermined range corresponding to the non P position (e.g., any one of D, R, N), SBW-ECU 50 determines that the current shift position is the non P position.

SBW-ECU 50 detects the amount of rotation of actuator 42 from the counter value detected by encoder 46.

SBW-ECU 50 sets the position of at least one of a plurality of shift positions, based on the actuator's rotational position restricted by a restriction member. Thus, SBW-ECU 50 determines from the counter value detected by encoder 46 whether the shift position is the P, R, N or D position.

Note that SBW-ECU 50 may determine the location of the shift position from the output value of output shaft sensor 44 in place of or in addition to encoder 46, or may determine the location of the shift position by a neutral start switch.

In shift control system 10 thus configured the present invention is characterized in that if actuator 42 is driven, in disengaging a shift position (1) of a plurality of shift positions in response to a switching signal, for the first time at earliest after actuator 42 becomes drivable, then, before the shift position (1) is switched to a destined shift position (2) in response to the switching signal, SBW-ECU 50 drives actuator 42 to switch the shift position (1) via another shift position of the plurality of shift positions other than the shift position (1) to determine whether a shift position attained after actuator 42 is driven is different from the other shift position and hence whether shift switching mechanism 48 has some failure. While in the present embodiment the shift position (1) is described as the P position, it is not limited thereto, and may for example be a non-driving position such as the N position.

Furthermore, if actuator 42 is driven for the first time, as described above, the plurality of shift positions are switched in a predetermined sequence with the shift position (1) serving as a starting point. In the present embodiment if actuator 42 is driven for the first time as described above SBW-ECU 50 determines whether shift switching mechanism 48 has failed between the shift position (1) and a sequentially last shift position. When the destined shift position, or the shift position (2), is not the sequentially last shift position, actuator 42 is driven to switch the current shift position to the sequentially last shift position to determine whether shift switching mechanism 48 has failed. In the present embodiment the “sequentially last shift position” is the D position.

“Fail” means that a rotor in actuator 42, a gear of speed reduction mechanism 68, a manual shaft in automatic transmission 30, detent plate 100, and/or the manual valve's spool mechanically fail/fails and a shift position cannot be switched normally.

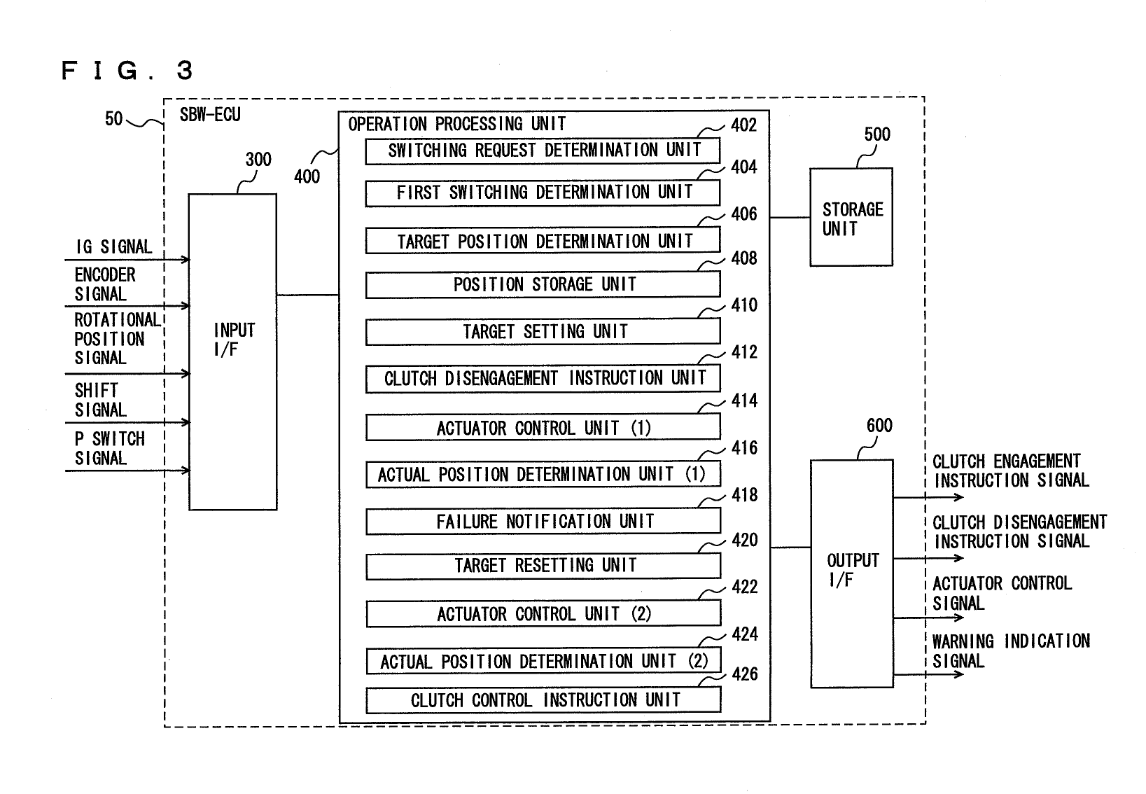

FIG. 3 is a functional block diagram of SBW-ECU 50 serving as the failure determination device for the shift switching mechanism according to the present embodiment.

SBW-ECU 50 includes an input interface (hereinafter referred to as input I/F) 300, an operation processing unit 400, a storage unit 500, and an output interface (hereinafter referred to as output I/F) 600.

Input I/F 300 receives an IG signal from IG switch 62, an encoder (or count) signal from encoder 46, a rotational position signal from output shaft sensor 44, a shift signal from shift switch 24, and a P command signal from P switch 22, and transmits the signals to operation processing unit 400.

Operation processing unit 400 includes a switching request determination unit 402, a first switching determination unit 404, a target position determination unit 406, a position storage unit 408, a target setting unit 410, a clutch disengagement instruction unit 412, an actuator control unit (1) 414, an actual position determination unit (1) 416, a failure notification unit 418, a target resetting unit 420, an actuator control unit (2) 422, an actual position determination unit (2) 424, and a clutch control instruction unit 426. Operation processing unit 400 is implemented for example as a central processing unit (CPU).

When the P position is selected, switching request determination unit 402 determines from a shift signal whether there is a request to switch to a shift position other than the P position. For example, when switching request determination unit 402 determines that there is a request to switch from the P position to another shift position, a switching request flag may be set.

First switching determination unit 404 determines whether the switching from the P position to another shift position, as determined, is doing so for the first time after engine 70 has been started. For example, first switching determination unit 404 may be turned on whenever engine 70 is started, and when a flag that is cleared when a shift position is switched to another shift position is set, first switching determination unit 404 may determine that the switching from the P position to another shift position, as determined, is doing so for the first time.

In the present embodiment, first switching determination unit 404 determines whether the switching is doing so for the first time after engine 70 is started. However, it is not limited to doing so after engine 70 is started; first switching determination unit 404 may determine whether a switching request is a switching request made for the first time at earliest after a temporal point at which IG switch 62 is turned on and actuator 42 becomes drivable. Alternatively, for example, if an ACC power supply relay turned on renders actuator 42 drivable, first switching determination unit 404 may determine whether the switching is doing so for the first time after the ACC is turned on. Furthermore, first switching determination unit 404 may determine whether the switching is doing so for the first time after engine 70 is started and whether the switching is also doing so for the first time for the day.

Furthermore, when first switching determination unit 404 for example determines that the switching is doing so for the first time after engine 70 is started, a first switching determination flag may be set.

Target position determination unit 406 determines whether a destined shift position based on a shift signal (hereinafter referred to as a “target shift position”) is the D position. For example, when target position determination unit 406 determines that the target shift position is the D position, a D position determination flag may be set.

Position storage unit 408 stores the target shift position to storage unit 500 if after the engine is started the P position is for the first time switched to another position and the target shift position is not the D position. Position storage unit 408 may store the target shift position to storage unit 500 for example when the switching request flag and the first switching determination flag are set and the D position determination flag is not set.

When the target shift position is stored to storage unit 500, target setting unit 410 sets the D position as the current target shift position. Clutch disengagement instruction unit 412 generates a clutch disengagement instruction signal to disengage start clutch 32 of automatic transmission 30 and transmits the clutch disengagement instruction signal via output I/F 600 to ECT-ECU 52. ECT-ECU 52 receives the clutch disengagement instruction signal, and, in response thereto, generates a hydraulic pressure control signal to disengage start clutch 32 and transmits the signal to a solenoid that varies the engagement force of start clutch 32. If the frictional engagement element engaging whenever the vehicle starts moving forward and the frictional engagement element engaging whenever the vehicle starts moving rearward are different, clutch disengagement instruction unit 412 issues an instruction to disengage both of the frictional engagement elements.

When a target shift position is set and the start clutch is disengaged, actuator control unit (1) 414 controls actuator 42 so that an actual shift position detected based on the encoder signal and/or the rotational position signal attains the set target shift position. Actuator control unit (1) 414 generates and transmits an actuator control signal via output I/F 600 to actuator 42.

Actual position determination unit (1) 416 determines whether the actual shift position corresponds to the target shift position. More specifically, actual position determination unit (1) 416 determines whether the actual shift position corresponds to the target shift position from a count value of encoder 46 varying as actuator control unit (1) 414 drives actuator 42, or a rotational position of shaft 102 sensed by output shaft sensor 44.

Note that actual position determination unit (1) 416 may determine whether the actual shift position corresponds to the target shift position for example after a predetermined period of time elapses, i.e., when it is expected that moving to the target shift position has been completed since driving actuator 42 was started. Alternatively, actual position determination unit (1) 416 may determine whether the actual shift position corresponds to the target shift position for example when shaft 102 attains a rotation speed of a predetermined value or lower. Furthermore, actual position determination unit (1) 416 may set a failure determination flag when actual position determination unit (1) 416 determines that the actual shift position does not correspond to the target shift position.

Failure notification unit 418 issues a warning to meter 58 or the like to visually or audibly notify the driver that shift switching mechanism 48 has failed. For example, when the failure determination flag is set, failure notification unit 418 generates and transmits a warning indication signal via output I/F 600 to meter 58.

When it is determined that the actual shift position corresponds to the target shift position, target resetting unit 420 resets as the current target shift position the shift position that has been stored in storage unit 500. Target resetting unit 420 may reset the stored shift position as the target shift position for example when the failure determination flag is not set.

Actuator control unit (2) 422 controls actuator 42 so that the actual shift position attains the target shift position reset by target resetting unit 420. Actuator control unit (2) 422 generates and transmits an actuator control signal via output I/F 600 to actuator 42.

Actual position determination unit (2) 424 determines whether the actual shift position corresponds to the target shift position. Note that when actual position determination unit (2) 424 determines that the actual shift position corresponds to the target shift position, an actual position determination flag may be set, for example.

After it is determined that the actual shift position corresponds to the target shift position, clutch control instruction unit 426 issues an instruction to control a clutch in accordance with the actual shift position.

For example, when the actual shift position is the D position or the R position, clutch control instruction unit 426 generates a clutch engagement instruction signal for engaging start clutch 32 and transmits the clutch engagement instruction signal via output I/F 600 to ECT-ECU 52.

ECT-ECU 52 receives the clutch engagement instruction signal, and, in response, generates and transmits a hydraulic pressure control signal to a solenoid to engage start clutch 32 or a rearward start clutch.

Clutch control instruction unit 426 does not issue an instruction to engage start clutch 32 when the actual shift position is the N position.

When the frictional engagement element engaging whenever the vehicle starts moving forward and the frictional engagement element engaging whenever the vehicle starts moving rearward are different, the frictional engagement element that corresponds to the actual shift position is engaged.

Note that for example when the actual position determination flag is set, clutch control instruction unit 426 may transmit to ECT-ECU 52 the clutch engagement instruction signal corresponding to the actual shift position.

While in the present embodiment, switching request determination unit 402, first switching determination unit 404, target position determination unit 406, position storage unit 408, target setting unit 410, clutch disengagement instruction unit 412, actuator control unit (1) 414, actual position determination unit (1) 416, failure notification unit 418, target resetting unit 420, actuator control unit (2) 422, actual position determination unit (2) 424, and clutch control instruction unit 426 are all described as functioning as software implemented by operation processing unit 400, i.e., a central processing unit (CPU), executing a program stored in storage unit 500, these units may be implemented as hardware. The program is stored in a storage medium and mounted on the vehicle.

Storage unit 500 has a variety of types of information, a program(s), a threshold value(s) a map(s) and the like stored therein, and operation processing unit 400 reads data therefrom and stores data thereto as required.

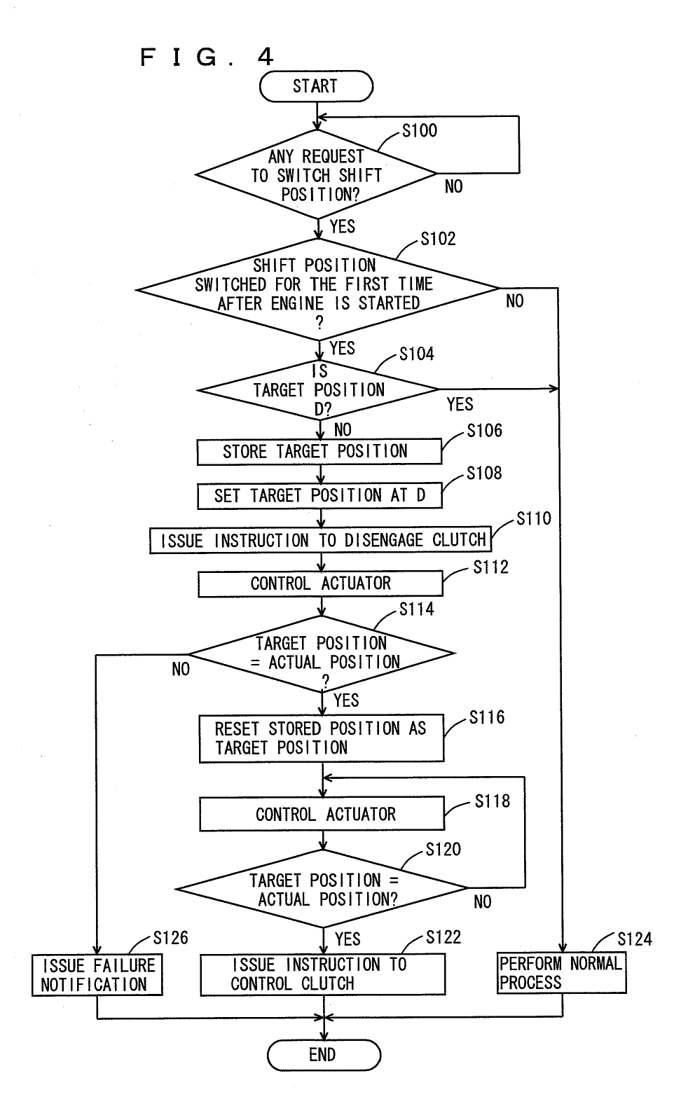

Hereinafter reference will be made to FIG. 4 to describe a control structure of a program executed in SBW-ECU 50 serving as a vehicular control device according to the present embodiment.

At step (S)100, SBW-ECU 50 determines whether there is a request to switch from the P position to another shift position. If so (YES at S100), the control proceeds to S102. Otherwise (NO at S100), the control returns to S100.

At S102, SBW-ECU 50 determines whether the switching from the P position to another shift position is doing so for the first time after engine 70 has been started. If so (YES at S102), the control proceeds to S104. Otherwise (NO at S102), the control proceeds to S124.

At S104, SBW-ECU 50 determines from a shift signal whether the target shift position is the D position. If so (YES at S104), the control proceeds to S124. Otherwise (NO at S104), the control proceeds to S106.

At S106, SBW-ECU 50 stores the target shift position. At S108, SBW-ECU 50 sets the current target shift position at the D position. At S110, SBW-ECU 50 issues an instruction to disengage start clutch 32.

At S112, SBW-ECU 50 controls actuator 42 so that the actual shift position attains the set target shift position. At S114, SBW-ECU 50 determines whether the actual shift position corresponds to the target shift position. If so (YES at S114), the control proceeds to S116. Otherwise (NO at S114), the control proceeds to S126.

At S116, SBW-ECU 50 resets the shift position that has been stored at S106 as the current target shift position. At S118, SBW-ECU 50 controls actuator 42 to attain the reset target shift position

At S120, SBW-ECU 50 determines whether the actual shift position corresponds to the target shift position. If so (YES at S120), the control proceeds to S122. Otherwise (NO at S120), the control returns to S118.

At S122, SBW-ECU 50 issues an instruction to control a clutch in accordance with the actual shift position. At S124, SBW-ECU 50 performs a normal process. More specifically, when the target shift position based on the shift signal and the actual shift position are different, SBW-ECU 50 controls actuator 42 to attain the target shift position. At S126, SBW-ECU 50 notifies the driver that it has detected that shift switching mechanism 48 has some defect.

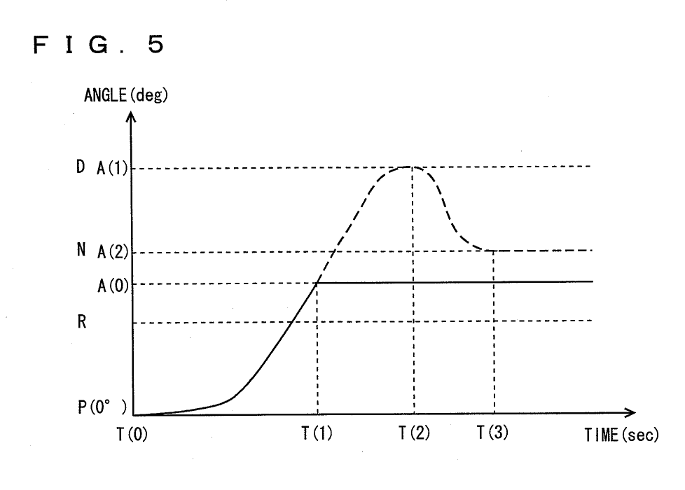

In accordance with the above described structure and flowchart, the present embodiment provides a failure determination device, or SBW-ECU 50, for a shift switching mechanism, that operates, as will be described hereinafter with reference to FIG. 5.

For example, the vehicle is stopped and engine 70 is also stopped, and the current shift position is the P position, for the sake of illustration. When the driver turns on IG switch 62 to power on the vehicle, a status allowing electric power to be supplied to actuator 42 is attained. That is, actuator 42 is drivable. Furthermore, when the driver performs an operation to drive starter 72, engine 70 starts.

At time T(0), for example after the driver starts engine 70 the driver moves the shift position to the N position for the sake of illustration. SB-ECU 50 receives a shift signal corresponding to the N position, and as the actual shift position is the P position, it is determined that there is a request to switch the shift position (YES at S100). Furthermore, as the switching requested is switching for the first time after engine 70 is started (YES at S102) and the target shift position is the N position (NO at S104), that the target position based on the shift signal is the N position is stored (S106) and the D position is set as the current target position (S108). Furthermore, an instruction is issued to disengage start clutch 32 (S110), and actuator 42 is controlled so that the shift position attains the D position (S112).

Shift Switching Mechanism in Normal Operation

At time T(0), driving actuator 42 is started, and, as shown in FIG. 5, shaft 102 (or detent plate 100) increases in angle of rotation. In FIG. 5, the horizontal axis represents time and the vertical axis represents shaft 102 in angle of rotation.

After time T(0), shaft 102 has an angle of rotation varying toward the D position with time, and, as indicated in FIG. 5 by a broken line, it attains an angle of rotation A(1) corresponding to the D position at time T(2). At the time, the actual shift position corresponds to the target shift position (YES at S114), and the stored N position is reset as the current target shift position (S116).

As actuator 42 is controlled to attain the reset shift position (S118), shaft 102 has its angle of rotation varied toward the N position, and at time T(3) an angle of rotation A(2) corresponding to the N position is attained. At the time, the actual shift position corresponds to the target shift position (YES at S120) and the actual shift position is the N position, and accordingly, an instruction to engage start clutch 32 is not issued. (S122).

<Shift Switching Mechanism Not In Normal Operation>

At time T(0), driving actuator 42 is started, and, as shown in FIG. 5, shaft 102 increases in angle of rotation.

After time T(0), shaft 102 has an angle of rotation varying toward the D position with time. At time T(1), automatic transmission 30 has its manual valve stuck or the like and the rotation of shaft 102 is accordingly limited, and accordingly, an angle of rotation A(0) is held. Accordingly, the actual shift position does not correspond to the target shift position (NO at S114), and the driver is notified that shift switching mechanism 48 has some failure (S126). Note that a clutch associated with moving the vehicle is disengaged, and the vehicle can be prevented from behaving against the driver's intention while shift switching mechanism 48 has some failure.

Thus the present invention in the present embodiment provides a failure determination device for a shift switching mechanism such that in switching for the first time after the engine is started, an actuator is driven to switch the P position to a destined shift position after the P position is switched via another shift position to determine whether the shift switching mechanism has failed so that whether the shift switching mechanism has failed can be detected at an early stage before the vehicle starts to travel. Furthermore, with the vehicle stopped, detecting that the shift switching mechanism has failed for example when the frictional engagement element that is engaged when the vehicle starts moving is disengaged to interrupt power that is transmitted to a driving wheel or the like to restrict the vehicle's movement, can prevent the vehicle from behaving against the driver's intention. A failure determination device for a shift switching mechanism and a failure determination method that can detect at an early stage that the shift switching mechanism has some failure, can thus be provided.

Furthermore, by determining whether the shift switching mechanism has failed between the P position and the D position, whether the shift switching mechanism has some failure can be detected for any shift position.

Furthermore, when the destined shift position is not the D position, the actuator can be driven to switch the shift position to the D position to determine whether the shift switching mechanism has failed so that whether the shift switching mechanism has some defect can be detected for any shift position.

While the present embodiment has been described to apply the present invention to a vehicle having an automatic transmission mounted therein, the present invention may be applied to a hybrid vehicle.

For example, if the actuator is driven, in disengaging the P position, for the first time after the actuator becomes drivable, then, before the P position is switched to a destined shift position, the actuator may be driven to switch the P position to another one of a plurality of shift positions other than the P position to determine whether the shift switching mechanism has failed. This can also achieve an effect similar to that exhibited when the present invention is applied to a vehicle having an automatic transmission mounted therein.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### DESCRIPTION OF THE REFERENCE SIGNS

10: shift control system, 20: shift operation unit, 22: switch, 24: shift switch, 30: automatic transmission, 32: start clutch, 40: actuator unit, 42: actuator, 44: output shaft sensor, 46: encoder, 48: shift switching mechanism, 58: meter, 62: switch, 68: speed reduction mechanism, 70: engine, 72: starter, 100: detent plate, 102: shaft, 104: rod, 106: parking lock pole, 108: parking lock gear, 110: detent spring, 120: location of position, 122: crest, 124: location of position, 300: input FF, 400: operation processing unit, 402: switching request determination unit, 404: first switching determination unit, 406: target position determination unit, 408: position storage unit, 410: target setting unit, 412: clutch disengagement instruction unit, 418: failure notification unit, 420: target resetting unit, 426: clutch control instruction unit, 500: storage unit, 600: output I/F.

1. A failure determination device for a shift switching mechanism mounted in a vehicle, said shift switching mechanism being operative in response to a switching signal to switch a shift position corresponding to a traveling state of said vehicle to any one of a plurality of shift positions as an actuator is driven, the failure determination device comprising:
a determination unit for determining whether said actuator is driven, in disengaging a first shift position of said plurality of shift positions in response to said switching signal, for a first time at earliest after said actuator becomes drivable; and
a fail determination unit for determining whether said shift switching mechanism has failed from whether a shift position attained after said actuator is driven is different from another shift position of said plurality of shift positions other than said first shift position, as said actuator is driven to switch said first shift position via said other shift position before switching said first shift position to a destined, second shift position in response to said switching signal if said determination unit determines that said actuator is driven for the first time.

2. The failure determination device for a shift switching mechanism according to claim 1, wherein:
if said determination unit determines that said actuator is driven for the first time then, said plurality of shift positions are switched in a predetermined sequence with said first shift position serving as a starting point; and
if said determination unit determines that said actuator is driven for the first time then, said fail determination unit determines whether said shift switching mechanism has failed between said first shift position and a sequentially last shift position.

3. The failure determination device for a shift switching mechanism according to claim 2, wherein if said second shift position is not said sequentially last shift position, said fail determination unit determines whether said shift switching mechanism has failed as said actuator is driven to switch a current shift position to said sequentially last shift position.

4. The failure determination device for a shift switching mechanism according to claim 1, wherein:
said vehicle has an engine; and
said fail determination unit determines whether said shift switching mechanism has failed when it is determined that said actuator is driven for a first time after said engine is started.

5. The failure determination device for a shift switching mechanism according to claim 1, wherein:
said other shift position includes a forward driving position;
said first shift position is switched to said forward driving position via a shift position other than said first shift position and said forward driving position; and
if said determination unit determines that said actuator is driven for the first time then, said fail determination unit determines whether said shift switching mechanism has failed as said actuator is driven to switch said first shift position to said forward driving position before switching said first shift position to said second shift position.

6. The failure determination device for a shift switching mechanism according to claim 1, wherein said first shift position is a parking position.

7. The failure determination device for a shift switching mechanism according to claim 1, further comprising:
a storage unit for storing said second shift position; and
an actuator control unit for controlling said actuator to switch said first shift position to said second shift position as stored, if it is determined that said shift switching mechanism has not failed in switching to said other shift position.

8. The failure determination device for a shift switching mechanism according to claim 1, wherein:
said vehicle is provided with a restriction device for restricting said vehicle's movement; and
said fail determination unit determines whether said shift switching mechanism has failed when said restriction device operates to restrict said vehicle's movement.

9. A failure determination method for a shift switching mechanism mounted in a vehicle, said shift switching mechanism operative in response to a switching signal to switch a shift position corresponding to a state of said vehicle to any one of a plurality of shift positions as an actuator is driven, the failure determination method comprising the steps of:
determining whether said actuator is driven, in disengaging a first shift position of said plurality of shift positions in response to said switching signal, for a first time at earliest after said actuator becomes drivable; and
determining whether said shift switching mechanism has failed from whether a shift position attained after said actuator is driven is different from another shift position of said plurality of shift positions other than said first shift position, as said actuator is driven to switch said first shift position via said other shift position before switching said first shift position to a destined, second shift position in response to said switching signal if it is determined that said actuator is driven for the first time.

10. The failure determination method for a shift switching mechanism according to claim 9, wherein:
if it is determined that said actuator is driven for the first time then, said plurality of shift positions are switched in a predetermined sequence with said first shift position serving as a starting point; and
if it is determined that said actuator is driven for the first time then, the step of determining whether said shift switching mechanism has failed determines whether said shift switching mechanism has failed between said first shift position and a sequentially last shift position.

11. The failure determination method for a shift switching mechanism according to claim 10, wherein if said second shift position is not said sequentially last shift position, the step of determining whether said shift switching mechanism has failed determines whether said shift switching mechanism has failed as said actuator is driven to switch a current shift position to said sequentially last shift position.

12. The failure determination method for a shift switching mechanism according to claim 9, wherein:
said vehicle has an engine; and
the step of determining whether said shift switching mechanism has failed determines whether said shift switching mechanism has failed when it is determined that said actuator is driven for a first time after said engine is started.

13. The failure determination method for a shift switching mechanism according to claim 9, wherein:
said other shift position includes a forward driving position;
said first shift position is switched to said forward driving position via a shift position other than said first shift position and said forward driving position; and
if it is determined that said actuator is driven for the first time then, the step of determining whether said shift switching mechanism has failed determines whether said shift switching mechanism has failed as said actuator is driven to switch said first shift position to said forward driving position before switching said first shift position to said second shift position.

14. The failure determination method for a shift switching mechanism according to claim 9, wherein said first shift position is a parking position.

15. The failure determination method for a shift switching mechanism according to claim 9, further comprising the steps of:
storing said second shift position; and
controlling said actuator to switch said first shift position to said second shift position as stored, if it is determined that said shift switching mechanism has not failed in switching to said other shift position.

16. The failure determination method for a shift switching mechanism according to claim 9, wherein:
said vehicle is provided with a restriction device for restricting said vehicle's movement; and
the step of determining whether said shift switching mechanism ) has failed determines whether said shift switching mechanism has failed when said restriction device operates to restrict said vehicle's movement.
